(19) United States
(12) Patent Application Publication
(10) Pub. No.: US 2009/0178317 A1
(43) Pub. Date: Jul. 16, 2009

(54) Sign with waterproof pocket

(76) Inventor: John E. Adams, Clarkston, MI (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/314,322

(22) Filed: Dec. 8, 2008

Related U.S. Application Data
(60) Provisional application No. 61/006,420, filed on Jan. 11, 2008.

(51) Int. Cl. G09F 15/00

(52) U.S. Cl. 40/606.1

(57) ABSTRACT

The sign with a waterproof pocket provides an advertising or display sign that allows the user to customize the information displayed thereon. The sign includes a panel adapted for having user-selectable indicia formed thereon. The panel is preferably formed from a waterproof or water-resistant material, allowing the sign to be displayed outdoors without suffering from weather or water-related damage. A pocket is mounted to the panel, with the pocket having opposed open and closed ends. The pocket is formed from a waterproof and transparent material, such as transparent plastic, and is provided with a releasable closure for the open end. Additional display media may be removably inserted within the transparent pocket for display on the sign. The display media may be a smaller panel or other display signage, or may include items for removal by potential customers, such as brochures, business cards or the like.

### CROSS-REFERENCE TO RELATED APPLICATION

This application claims the benefit of U.S. Provisional Patent Application Ser. No. 61/006,420, filed Jan. 11, 2008.

### BACKGROUND OF THE INVENTION

1. Field of the Invention

The present invention relates to signs and displays, and particularly to a sign with a waterproof pocket that is transparent and allows a user to customize the information displayed on the sign.

2. Description of the Related Art

Signs for personal usage, such as “For Sale” signs and the like, typically include a relatively small panel permanently affixed to a stake for insertion into the ground. The panel includes display indicia that are generic and provided for a wide variety of users. Such signs are typically only customizable through the addition of words manually painted or printed onto the face of the panel by the user. The printed information by the user is susceptible to being rubbed off or washed off during inclement weather and other harsh environmental conditions.

Further, such signs are not equipped for the dispensing of further advertising or display media, such as brochures, business cards or the like. Although displays that further provide for the dispensing of brochures are known, such displays typically include a basket or other type of open container mounted to the face of the panel, allowing passersby to remove one or more items therefrom. Such displays are typically used indoors, since the baskets or containers are open and are, thus, susceptible to water and other weather-related damage. Thus, a sign with a waterproof pocket solving the aforementioned problems is desired.

### SUMMARY OF THE INVENTION

The sign with a waterproof pocket provides an advertising or display sign that allows the user to customize the information displayed thereon. The sign includes a panel having opposed front and rear surfaces, with the front surface being adapted for having user-selectable indicia formed thereon in a conventional manner. The panel is preferably formed from a waterproof or water-resistant material, such as plastic, treated cardboard or the like, allowing the sign to be displayed outdoors without suffering from weather or water-related damage.

A pocket is mounted to the front surface of the panel, with the pocket having opposed open and closed ends. The pocket is formed from a waterproof and transparent material, such as transparent plastic, and is provided with a releasable closure for the open end, such as a bead-and-groove or Ziploc® fastener. The releasable closure is preferably also waterproof.

Additional display media may be removably inserted within the transparent pocket for display on the sign. The display media may be a smaller panel or other display signage, or may include items for removal by potential customers, such as brochures, business cards or the like.

These and other features of the present invention will become readily apparent upon further review of the following specification and drawings.

### BRIEF DESCRIPTION OF THE DRAWINGS

FIG. 1 is an environmental, perspective view of a sign with a waterproof pocket according to the present invention.

FIG. 2 is a front view of the sign with a waterproof pocket according to the present invention, including a first example of display media being used therewith.

FIG. 3 is a front view of the sign with a waterproof pocket according to the present invention, including a second example of display media being used therewith.

Similar reference characters denote corresponding features consistently throughout the attached drawings.

### DETAILED DESCRIPTION OF THE PREFERRED EMBODIMENTS

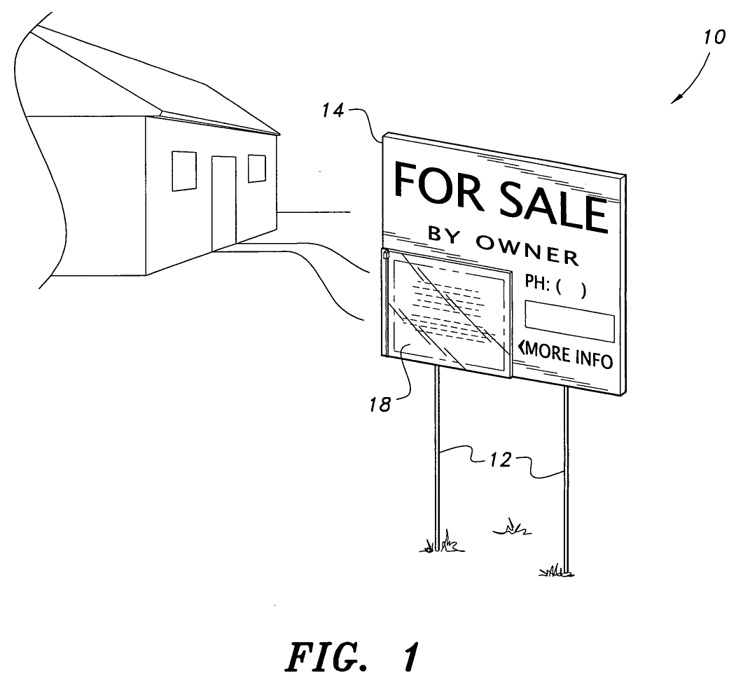

The present invention relates to a sign with a waterproof pocket 10, which provides an advertising or display sign allowing the user to customize the information displayed thereon. In FIG. 1, the sign 10 is shown as being a rectangular, real estate-related “For Sale” type sign. It should be understood that sign 10, shown in FIGS. 1-3, may be any type of display and that the indicia, dimensions, theme and shape thereof are shown for exemplary purposes only.

The sign 10 includes a panel 14 having opposed front and rear surfaces, with the front surface being adapted for having user-selectable indicia 16 formed thereon in a conventional manner. Indicia 16 is shown in the drawings for exemplary purposes only, and it should be understood that any desired indicia may be formed thereon. In the drawings, only the front surface of the panel is shown, although it should be understood that the rear panel may also have indicia formed thereon, if desired by the user. The panel 14 is preferably formed from a waterproof or water-resistant material, such as plastic, treated cardboard or the like, allowing the sign to be displayed outdoors without suffering from weather-related damage.

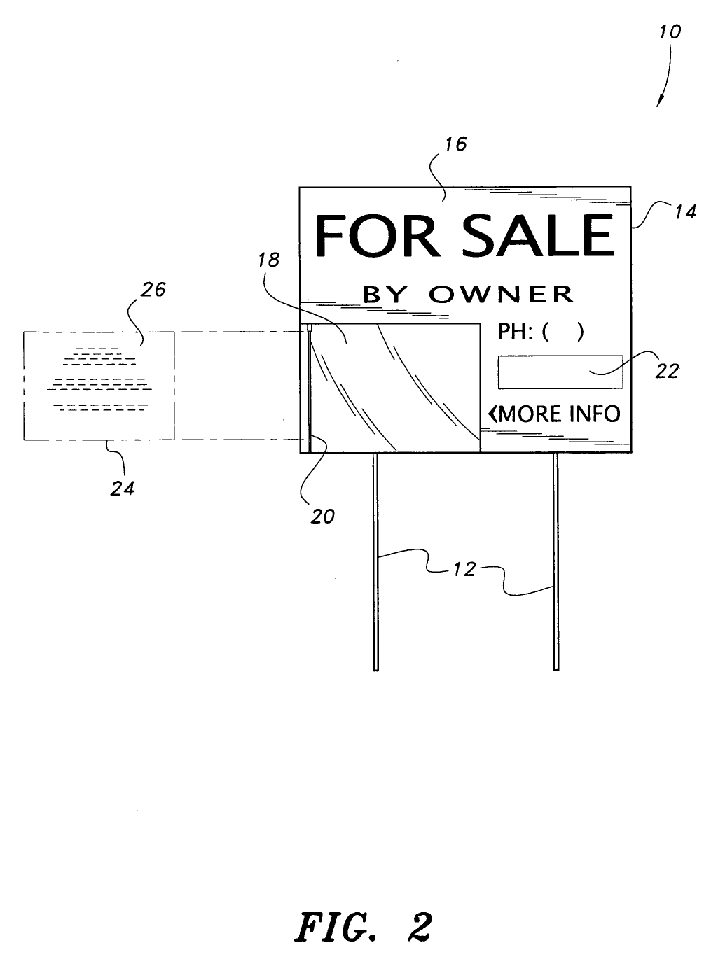

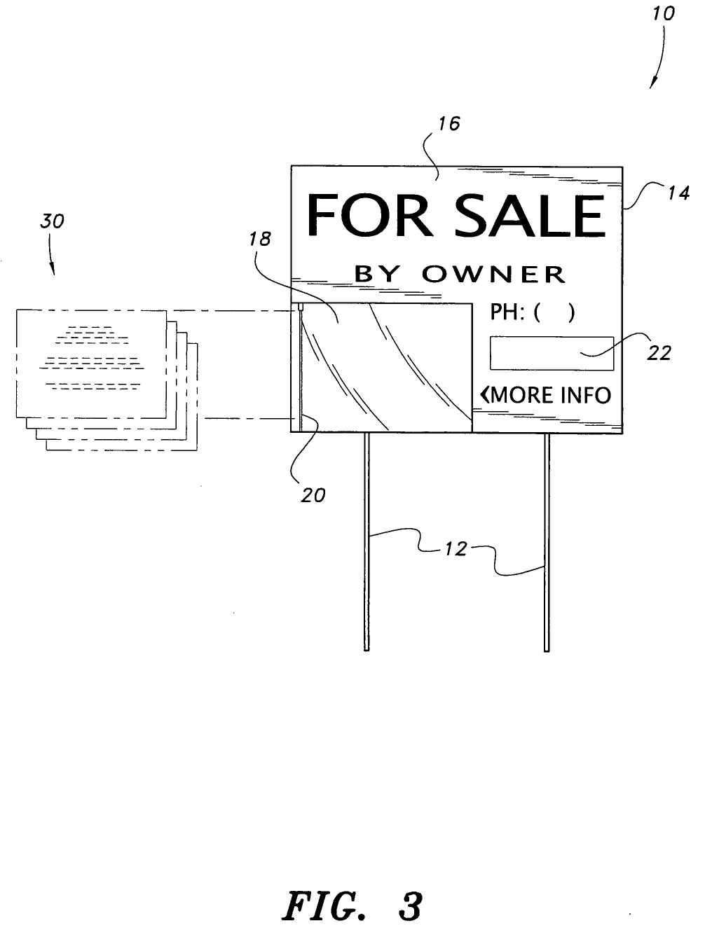

Sign 10 is provided with a stand or support for mounting the sign 10 on the ground (as shown in FIG. 1) or on any other suitable support surface. Legs 12, best shown in FIGS. 2 and 3, are adapted for insertion into the ground, although it should be understood that any suitable type of support may be provided, depending upon the environment in which the sign 10 is to be displayed and depending upon the nature of the support surface. Legs 12 are rigid, elongated posts or the like, which are fixed at their upper ends to the panel 14.

A pocket 18 is mounted to the front surface of the panel 14, with the pocket 18 having opposed open and closed ends. The pocket 18 is formed from a waterproof and transparent material, such as transparent plastic, and is provided with a releasable closure for the open end. The releasable closure may be a bead-and-groove fastener 20, for example. The pocket 18 and releasable fastener 20 may be a resealable plastic bag, such as those manufactured under the mark Ziploc® by S.C. Johnson Home Storage, Inc. of Racine, Wis., for example.

The pocket 18 may have any desired size, shape or dimensions, depending upon the additional display media to be inserted therein. In addition to the indicia 16 formed on the panel 14, the user may wish to display further information. As shown in FIG. 2, additional display media, in the form of a secondary, smaller panel 24 or other display, may be removably inserted within the transparent pocket 18 for display on the sign 10 through the transparent wall of the pocket 18. The smaller panel 24 may be printed by the user on a home computer on standard printer paper, for example, or may be formed in any other suitable manner, so that it displays customizable indicia 26. Since the smaller panel 24 may be easily removed and replaced, the user may add customized information to the sign 10 through the removal and replacement of the smaller panel 24. The panel 14 is typically provided with generic indicia 16 (such as the “For Sale” lettering), and the insertion of the smaller panel 24 within pocket 18 allows for the addition of customized information, such as further seller's notes, contact information or the like.

As shown in FIGS. 2 and 3, the open end (and closure 20) of the pocket 18 is preferably positioned along one of the vertical edges of the panel 14. This allows for further protection of the display media held within the pocket 18 against water or other weather-related damage. Further, as shown in FIG. 3, the display media may include items for removal by potential customers, such as exemplary brochures 30, business cards or the like. The resealable closure 20 allows for secure storage of a multiple items within pocket 18. The smaller panel 24 of FIG. 2 may also be combined with the exemplary brochures 30 of FIG. 3, with both being held within the transparent pocket 18.

In use, the panel 14 may be imprinted with generalized indicia, such as the exemplary “For Sale” indicia 16 shown in the drawings, which may be utilized by a multitude of users. The user may further customize the panel 14 through insertion of personalized information, such as the user's phone number, in a space 22 or spaces provided for this information. Such information may be written in, or otherwise printed on the face of panel 14. The user may then make either a smaller, customized display panel, such as the exemplary smaller panel 24 shown in FIG. 2, for insertion within the pocket 18 (and for display through the transparent wall thereof), or provide a plurality of other media for potential customers to remove from the pocket 18, such as the exemplary brochures 30 shown in FIG. 3. The sign 10 is mounted on the ground or other support surface via legs 12 (or any other suitable support), and the user may removably seal the smaller panel 24 or the brochures 30 within the pocket 18 through use of the seal 20. This allows not only for display and storage of the additional media, but provides for protection of the additional media from the elements, since the pocket 18 is formed from a waterproof material and the seal is further waterproof.

It is to be understood that the present invention is not limited to the embodiments described above, but encompasses any and all embodiments within the scope of the following claims.

I claim:

1. A sign with a waterproof pocket, comprising:
a panel having opposed front and rear surfaces, the front surface being adapted for having user-selectable indicia formed thereon;
a pocket mounted on the front surface of the panel, the pocket having opposed open and closed ends, the pocket being formed from a waterproof material; and
means for sealing the open end of the pocket.

2. The sign with a waterproof pocket as recited in claim 1, wherein said pocket is further formed from a transparent material.

3. The sign with a waterproof pocket as recited in claim 1, wherein said means for sealing the open end of the pocket comprise a bead-and-groove fastener.

4. The sign with a waterproof pocket as recited in claim 1, wherein the open end of said pocket extends in a vertical direction.

5. The sign with a waterproof pocket as recited in claim 4, wherein the open end of said pocket is positioned adjacent and contiguous to a vertical edge of said panel.

6. The sign with a waterproof pocket as recited in claim 1, further comprising display media removably received within said pocket.

7. The sign with a waterproof pocket as recited in claim 1, further comprising a support adapted for supporting said panel.

8. The sign with a waterproof pocket as recited in claim 7, wherein said support comprises at least one elongated post, said panel being attached to said post.

9. A customizable sign, comprising:
a panel having opposed front and rear surfaces, the front surface being adapted for having user-selectable indicia formed thereon;
a support, the panel being attached to the support;
a pocket mounted on the front surface of the panel, the pocket having opposed open and closed ends, the pocket being formed from a transparent material; and
display media removably received within the pocket.

10. The customizable sign as recited in claim 9, wherein said pocket is formed from waterproof material.

11. The customizable sign as recited in claim 9, further comprising means for releasably sealing the open end of the pocket.

12. The customizable sign as recited in claim 11, wherein said means for releasably sealing the open end of the pocket comprises a bead-and-groove fastener.

13. The customizable sign as recited in claim 9, wherein the open end of said pocket extends in a vertical direction.

14. The customizable sign as recited in claim 13, wherein the open end of said pocket is positioned adjacent and contiguous to a vertical edge of said panel.

15. The customizable sign as recited in claim 9, wherein said support comprises at least one elongated post.
